(19) United States
(12) Patent Application Publication
(10) Pub. No.: US 2007/0150532 A1
(43) Pub. Date: Jun. 28, 2007

(54) System for generating a high-definition format in standard video instant messaging

(75) Inventors: Jay Feldis, Menlo Park, CA (US); Jean-Michel Chardon, Livermore, CA (US); Aaron Standridge, Poteau, OK (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 11/433,642

(22) Filed: May 12, 2006

Related U.S. Application Data
(60) Provisional application No. 60/754,735, filed on Dec. 28, 2005.

(51) Int. Cl. G06F 17/14

(52) U.S. Cl. 708/400

(57) ABSTRACT

A mechanism for generating a 16:9 aspect ratio video image or other non-standard format video for transmission to an application expecting a standard 4:3 image. Software or firmware is inserted between the camera and the application. The image is cropped to obtain the desired aspect ratio (e.g., 4:3 is cropped to give 16:9). Black bars of pixels are added outside the cropped image to make it an actual 4:3 format. A pop-up assistant appears when the target application (e.g., an instant messenger application) is launched, with the assistant providing the controls for switching to 16:9 or other non-standard format.

### CROSS-REFERENCES TO RELATED APPLICATIONS

This application claims the benefit of U.S. Provisional Patent Application No. 60/754,735, filed Dec. 28, 2005, entitled “System for Generating a High-Definition Format in Standard Video Instant Messaging”, which is hereby incorporated by reference in its entirety.

### BACKGROUND OF THE INVENTION

The present invention relates to video formatting for instant messenger applications, and in particular to providing a high-definition format to an instant messenger application expecting a standard format.

U.S. Pat. No. 5,541,654 shows selecting only a portion of the pixels of an image sensor to switch between 4:3 and 16:9 aspect ratios (see FIGS. 3A and 3B and accompanying discussion). U.S. Pat. No. 6,300,976 is similar, see FIG. 3. Publication No. 2004091256 shows selecting between multiple aspect ratios using vanes. The prior art also teaches zooming and cropping in a camera, where that can involve selecting a portion of an image on a sensor. Other prior art show different methods, such as interpolating (U.S. Pat. No. 6,300,976) and decimating (U.S. Pat. No. 5,280,240) to vary the aspect ratio.

U.S. Pat. No. 5,414,463 (in viewfinder), U.S. Pat. No. 6,636,266 and No. 6,414,714 show systems for varying an aspect ratio. Other patents and published applications relating to varying an aspect ratio or cropping include: U.S. Pat. No. 5,841,471, No. 5,784,103, No. 20040091256, No. 20040201742, No. 20040091257, No. 20030184674 and No. 20030194207.

### BRIEF SUMMARY OF THE INVENTION

The present invention provides a mechanism for generating a 16:9 aspect ratio video image or other non-standard format video for transmission to an application expecting a standard 4:3 image. Software or firmware is inserted between the camera and the application. The image is cropped to obtain the desired aspect ratio (e.g., 4:3 is cropped to give 16:9). Black bars of pixels are added outside the cropped image to make it an actual 4:3 format.

In one embodiment, a pop-up assistant appears when the target application (e.g., an instant messenger application) is launched, with the assistant providing the controls for switching to 16:9 or other non-standard format.

For a further understanding of the nature and advantages of the invention, reference should be made to the following description taken in conjunction with the accompanying drawings.

### BRIEF DESCRIPTION OF THE DRAWINGS

FIG. 1 is a diagram illustrating the system and user layers of software in an embodiment of a system incorporating the transformation features of the present invention.

FIG. 2 is a block diagram of an embodiment of a system incorporating the transformation features of the present invention.

FIG. 3 is a diagram of a sensor showing the image area.

FIG. 4 is a screen shot of an embodiment of an instant messenger application incorporating the transformation feature of the invention.

### DETAILED DESCRIPTION OF THE INVENTION

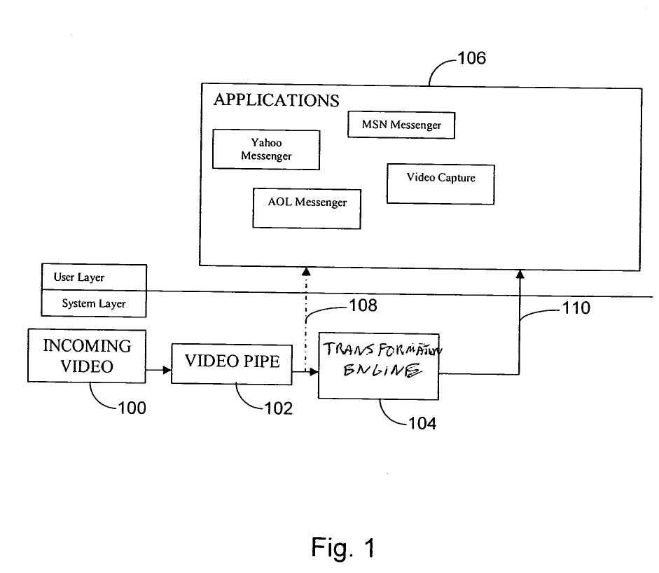

FIG. 1 illustrates the operation of one embodiment of the invention. Incoming video 100 is provided to a video pipe 102 which is received by the transformation engine 104 of the present invention. The video pipe can be provided directly to applications 106 as indicated by arrow 108, or can be provided to the transformation engine. The transformation engine provides a modified video pipe to the applications as indicated by arrow 110.

The modified video pipe can be used by any application that uses live video input. This includes instant messaging applications (MSN Messenger, Yahoo Messenger, AOL messenger, etc.) as well as video capture applications (when—for example—an artist is capturing the video to the disk). This means that the transformation can be applied before the video is captured to the disk and stored or before it is sent to the interlocutor on the other side of the communication channel. This is because the transformation engine is integrated into the system-level part of the software, which makes it transparent to the applications using the video stream that lay above the system layer at the user layer. In this way the present invention is generic—i.e. it can coexist with any video application and modify its input according to the settings on quick assistant.

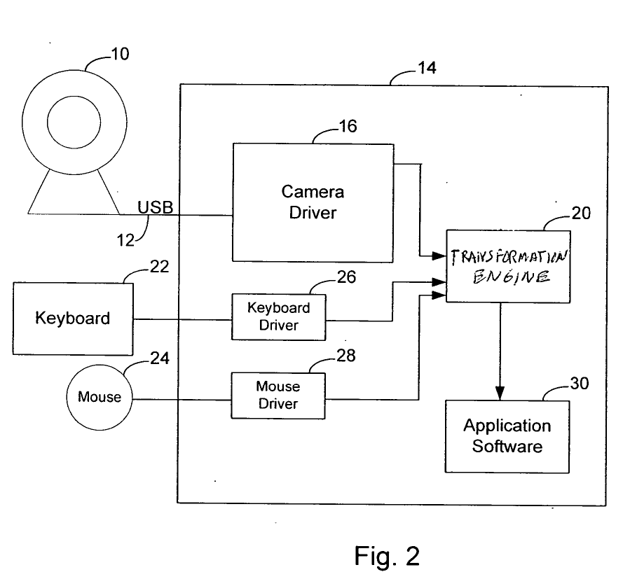

FIG. 2 is a block diagram of an embodiment of a system incorporating the transformation of the present invention. A web cam 10 is connected through a USB bus 12 to a computer 14. The USB bus 12 acts as a video feed from the camera to the computer. Alternately, a wireless USB feed could be provided, or any other bus or interface could be used to provide the video. Additionally, a camera, other than the web cam, or any other video source could be used. Additionally, the video source could come from within the computer or through a network to the computer from a remote source.

Computer 14 includes a camera driver 16 which receives the live video. The video is provided to a transformation module 20. The transformation module responds to user inputs to select the desired view, which corresponds to an aspect ratio, such as 16:9 for a wide view that can pick up two people. The user input can be provided through any peripheral, such as keyboard 22 or mouse 24 with associated keyboard driver 26 and mouse driver 28. After the transformation has been applied, the video feed is provided to application software 30. The application software could be an instant messenger application, a video conferencing application, or any other application which uses video.

FIG. 3 illustrates the area of an image on a sensor 200. The transformation module will, in response to selection of a 16:9 aspect ratio, substitute black pixels for the areas 202 and 204 of the image. The entire image can then be presented to an IM application which is expecting an image with an aspect ratio of 4:3. The image sensor is preferably a megapixel sensor, such that the image without the black bands is represented by 300,000 pixels or more.

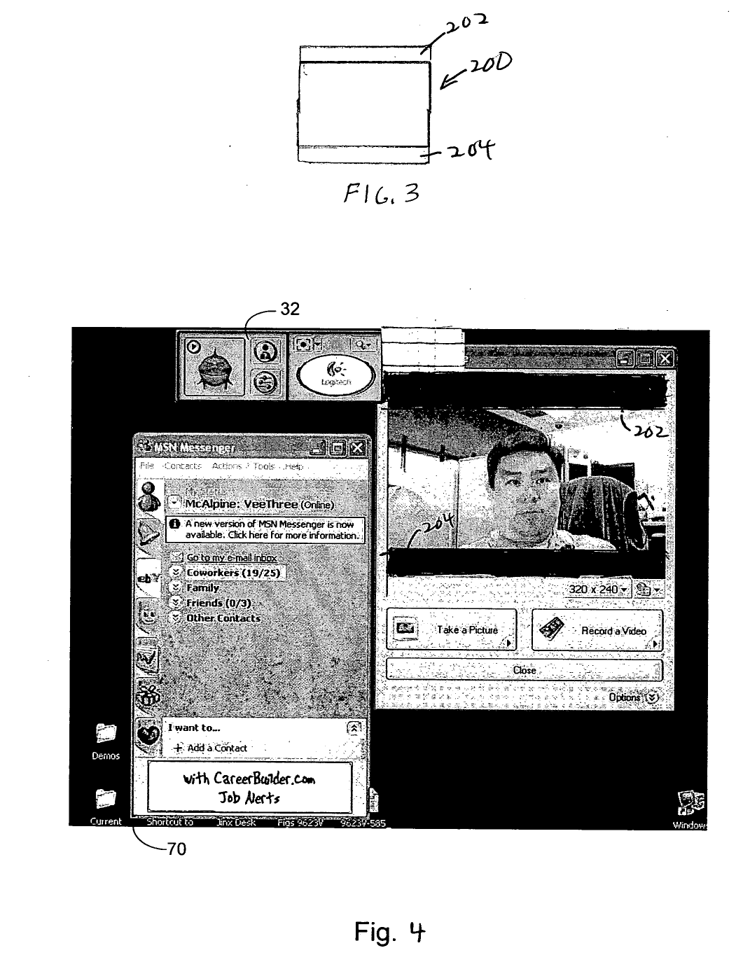

FIG. 4 shows a hovering dialog box 32, which is a quick assistant that will open and appear on the screen when live video is requested. This automatic activation is accomplished by the camera or video driver software, which detects when a request is made for a video feed from an application, such as an instant messenger application. The quick assistant will appear close to the window of the program that called for the live video, so it will appear as if it were part of that application. An example for instant messaging is shown, with instant messaging window 70. This provides an advantage in allowing the transformation application to work with third-party applications that use a video feed and need not be modified to accommodate the transformation engine. The user will typically assume that the quick assistant is part of that third-party application. This increases the ease of use and acceptation of the new technology.

The quick assistant can display a number of viewing options for the video with different aspect ratios. For example, aspect ratios of 2:1, 11:6, etc. could be used. The user can select from a drop-down list of these ratios, or common names could be used instead (wide-angle. rectangular, etc.). The 16:9 aspect ratio is especially useful for viewing two people. This is especially true for a webcam, where only the faces are desired, and the video above and below the faces is not needed, and can be eliminated with the black bars.

Although the black bands still require pixels to be sent, there is a tremendous savings in bandwidth compared to a full 4:3 ratio for the entire image. That is because the repetitive black pixels are easily quantified with minimal data by compression algorithms.

As will be understood by those of skill in the art, the present invention may be embodied in other specific forms without departing from the essential characteristics thereof. For example, the black bands could be applied to the sides, or could be curved to give the image a rounded shape. Accordingly, the foregoing description is intended to be illustrative, but not limiting, of the scope of the invention which is set forth in the following claims.

What is claimed is:

1. An apparatus for modifying the aspect ratio of a video image, comprising:
a video feed input for providing a video image in an original aspect ratio format;
a transformation engine for modifying a received image, said transformation engine being located between said video feed input and a user application for said video;
a user input for indicating a desired image aspect ratio;
wherein said transformation engine, responsive to said user input, modifies said video image by substituting groups of black pixels for areas of said video image to give the desired aspect ratio in a region of said video image not covered by said black pixels; and
wherein said transformation engine provides a transformed video image to said user application in said original aspect ratio format.

2. The apparatus of claim 1 further comprising:
a quick assistant module for providing a quick assistant user interface on a screen proximate a window for said user application, said quick assistant providing a user interface for said user input.

3. The apparatus of claim 1 wherein said user application is an instant messenger application.

4. The apparatus of claim 1 wherein an aspect ratio selectable by a user includes 16:9, and said original aspect ratio is 4:3.

5. An apparatus for modifying the aspect ratio of a video image, comprising:
a video feed input for providing a video image in an original aspect ratio format;
a transformation engine for modifying a received image, said transformation engine being located between said video feed input and a user application for said video;
a user input for indicating a desired image aspect ratio;
wherein said transformation engine, responsive to said user input, modifies said video image by substituting groups of black pixels for areas of said video image to give the desired aspect ratio in a region of said video image not covered by said black pixels; and
wherein said transformation engine provides a transformed video image to said user application in said original aspect ratio format;
a quick assistant module for providing a quick assistant user interface on a screen proximate a window for said user application, said quick assistant providing a user interface for said user input;
wherein said user application is an instant messenger application; and
wherein an aspect ratio selectable by a user includes 16:9, and said original aspect ratio is 4:3.
